(19) United States
(12) Patent Application Publication
(10) Pub. No.: US 2007/0068286 A1
(43) Pub. Date: Mar. 29, 2007

(54) Ultrasonic testing of pipe

(76) Inventor: John Piper, Mt. Keira (AU)

Correspondence Address: SNELL & WILMER, 400 EAST VAN BUREN, ONE ARIZONA CENTER, PHOENIX, AZ, 85004-2202, US

(21) Appl. No.: 10/558,940

(22) PCT Filed: May 12, 2004
(86) PCT No.: PCT/AU04/00620

§ 371 Date: Sep. 7, 2006

(30) Foreign Application Priority Data
Jun. 2, 2003 (AU) 2003902766

(51) Int. Cl. G01H 11/00; G01D 21/00

(52) U.S. Cl. 73/866.5; 73/649

(57) ABSTRACT

A device (10) for supporting an ultrasonic transducer used for ultrasonic defect testing of pipe comprises: a transducer locating portion (12) adapted for positioning adjacent to a pipe to locate the transducer in proximity of the pipe; and a guide surface (14) associated with the transducer locating portion such that, when the device is moved relative to the pipe, the guide surface can engage and traverse hindrances in the pipe to such relative device movement. Apparatus (50) for rotationally positioning one or more of the ultrasonic transducer supporting devices (10) in proximity of the pipe to enable ultrasonic defect testing thereof, comprises means (52) for rotating the or each device around at least part of the pipe's circumference whilst maintaining the or each device in proximity of the pipe. In addition, an arrangement for ultrasonic defect testing of lengths of pipe comprises: a support frame (150) in which two or more carriages (50) can be supported and moved, each carriage supporting one or more ultrasonic transducers for positioning in proximity of the pipe; and means (154) for positioning a length of pipe in proximity with one of the carriages.

### FIELD OF THE INVENTION

The present invention relates to a device and apparatus for improving the positioning and use of ultrasonic testing equipment in pipe defect detection. The invention finds particular application with seam welded pipe, but it should be appreciated that the invention is not so limited and may be used with extruded pipe, whether that pipe be formed from steel, steel alloys, other metals, plastics etc. The invention will be primarily described, however, with reference to its use with steel seam welded pipe. In this specification, the term “pipe” will be used to denote both tube and pipe, whether that tube or pipe is formed by seam welding, extrusion etc.

### BACKGROUND TO THE INVENTION

It is well known to defect test pipe, especially pressure pipe. Where the pipe is to be used in relatively high pressure applications (eg. in oil and gas pipe lines, chemical plants etc.) it is usually mandatory to test the pipe for defects which might otherwise give rise to leakage, pipe failure etc. in use. Such leakage or failure can have catastrophic consequences from both a safety and environmental perspective.

It is known to use ultrasonic inspection of pipe to check for defects, especially in the case of seam welded pipes. Defects may occur in the unwelded pipe wall material, but typically occur in and around the seam weld. Usually ultrasonic testing is employed to detect defects in and around the seam weld as this is the most likely area for occurrence and failure. Defects may occur parallel to the pipe longitudinal axis (“longitudinal defects”), perpendicular to this axis (“transverse defects”) and at orientations between these two (“oblique defects”). Ultrasonic inspection techniques are able to locate and identify such defects in both welded and unwelded pipe.

Ultrasonic inspection makes use of ultrasonic probes which are typically positioned in proximity of the pipe which is then moved past the probe. An ultrasonic probe typically employs a transducer, which usually comprises a piezo-electric crystal mounted in a plastic support and which is electrically actuated to vibrate and provide ultrasonic waves. A coupling medium (typically water) is provided between the transducer and the pipe and typically the waves enter the pipe wall at an angle and bounce between the outside diameter and inside diameter of the pipe wall. The soundwaves may be introduced to bounce around the tube's circumference (“circumferential testing”) or to move lengthwise through the pipe (“axial testing”). In either case, when the ultrasonic wave engages a defect (which can include the seam weld) it will be reflected thereby and bounce back to be received by the transducer. Thus, the transducer can act as both an ultrasonic wave generator and a reflected ultrasonic wave receiver, or a separate receiver can be provided.

Where the reflected ultrasonic wave engages a defect other than a seam weld of acceptable standard, controllers for the transducer can analyse and differentiate this reflected sound wave to determine the existence and the location of a defect.

In the mass production of pipe, particularly where long lengths of pipe are produced, bending, undulations and surface irregularities can be introduced into the pipe due to pipe forming inaccuracies or differential cooling throughout the pipe length, especially in the vicinity of the weld where present. Defects can also be caused by other pipe process steps, including seam welding irregularities, steel making irregularities and burring of pipe ends where the pipe lengths are cut. Such defects can interfere with known ultrasonic testing equipment.

For example, known ultrasonic transducers must be positioned inset from a cut pipe end during feeding of a pipe past the ultrasonic equipment because the ends of the pipe otherwise interfere with and can damage the transducers in use. Also, known transducers can experience difficulties when hindrances to relative transducer movement over the pipe surface are engaged, again leading to either loss of inspection, false readings, damage to the transducer, or all of these.

### SUMMARY OF THE INVENTION

In a first aspect the present invention provides a device for supporting an ultrasonic transducer used for ultrasonic defect testing of pipe, the device comprising:
a transducer locating portion adapted for positioning adjacent to a pipe to locate the transducer in proximity of the pipe; and
a guide surface associated with the transducer locating portion such that, when the device is moved relative to the pipe, the guide surface can engage and traverse hindrances in the pipe to such relative device movement.

The term “hindrances” is to be interpreted broadly and includes surface undulations and bevels at the ends of, or along a pipe, external surface defects in the pipe, and bumps, curvatures, bends etc. in the pipe external surface or wall etc., and which may otherwise interfere with the smooth traversing of an ultrasonic transducer across a pipe surface.

In addition, reference to a “relative” movement between the device and pipe indicates that the device can be moved along or around the pipe, or the pipe can be moved with respect to a fixed device, or any combination of these movements. Typically in use the pipe is moved lengthwise past the device, and typically the device is moved around the pipe.

Advantageously the present invention allows for the close positioning of an ultrasonic transducer (or other probe) to a pipe external surface, and the maintaining of this close positioning, thereby enhancing the effectiveness of ultrasonic signal propagation and signal receipt, and maximising coupling therebetween. In addition, because the guide surface may ride over initial pipe end hindrances, such as a bevel cut thereat, ultrasonic testing may commence at the beginning of a pipe section and continue right through to the opposing end of a pipe section, thus testing for any defects which may be present in those regions, and hence testing for a full length of pipe.

Whilst typically the device is used for positioning of an ultrasonic transducer in proximity of a pipe, the device can be used for positioning other probes in proximity of a pipe (eg. a pipe thickness probe, temperature probe etc). Thus, the terminology “transducer locating portion” should be interpreted to broadly to include a portion that allows for the location and positioning adjacent to a pipe of probes etc that employ other than transducers.

Preferably the guide surface is located forwardly in the transducer locating portion when the device is moved relatively lengthwise along the pipe. However, the guide surface may also or alternatively be located in either or both of lateral (side) regions of the transducer locating portion (eg. for relative rotational movement of the device around a pipe). The guide surface may also be located rearwardly in the transducer locating portion, for example, where the device is moved relatively rearwardly back along the pipe (eg. to retest a section). Typically, however, the guide surface is at least located forwardly in a transducer locating portion as such location adequately allows traversing of most pipe hindrances (including the hindrances at the ends of a pipe).

Preferably in use the guide surface extends obliquely with respect to a longitudinal axis of the pipe. In this regard, the guide surface can be planar, but may also be defined by a curved surface.

Preferably the guide surface is defined (i) at an end of the transducer locating portion, or (ii) as part of a flange extending away from the transducer locating portion.

Preferably in the case of (i) the guide surface is defined as a bevel undercut at an in-use forward end of the device. Preferably in the case of (ii) the flange extends away from an in-use forward end of the device and away from the pipe, and the guide surface is defined on a side of the flange facing the pipe. Preferably the guide surface in (i) and (ii) is planar. Thus, the guide surface can be formed on part of the transducer locating portion or may be formed on a flange or other element extending away from the transducer locating portion.

Preferably a transducer locator element is disposed within the transducer locating portion, into which element the transducer is mountingly located in use. The transducer locator element is typically arranged such that when the transducer is positioned therein, and when the device is moved to its in use position with reference to a pipe, the transducer is disposed in close proximity to the pipe external surface.

Preferably the transducer locator element laterally surrounds the transducer and is formed from a material resistant to the propagation of ultrasonic waves therethrough, such that ultrasonic waves are not directed laterally through the device in use. In this regard, the transducer locator element is preferably formed from a ring of polymeric material (eg. a polyurethane) positionable in a body of the transducer locator portion.

Preferably the transducer locating portion includes a curved in-use underside face for close-facing positioning with the pipe. Typically the curved surface is defined by a radius that is closely matched to a radius defining the external surface of the pipe. Again, this enables for close coupling between the transducer and the pipe.

Typically the device is adapted for mounting in an apparatus for moving the device relatively along and/or around and/or towards or away from the pipe in use. In this regard, typically the pipe is advanced into the apparatus (to be advanced past the transducer supporting device). Preferably the apparatus then moves the device towards or away from the pipe, or around the pipe in use. However, other variations are possible as described hereafter.

Preferably a plurality of ultrasonic transducer supporting devices are mountable in the apparatus.

In a second aspect the present invention provides an apparatus for rotationally positioning one or more ultrasonic transducer supporting devices in proximity of a pipe to enable ultrasonic defect testing thereof, the apparatus comprising means for rotating the or each device around at least part of the pipe's circumference whilst maintaining the or each device in proximity of the pipe.

Advantageously, the apparatus of the second aspect allows for ultrasonic inspection of pipe to be performed at a number of rotational positions around the pipe. In addition, the apparatus allows a pipe weld seam to be tracked by a transducer during pipe movement therepast (eg. where the seam is non-linear). For example, in a typical ultrasonic inspection of seam welded pipe, one or more ultrasonic transducers are initially located at or adjacent to a top dead centre of a pipe, with the seam weld also desirably being aligned with top dead centre. However, sometimes during pipe feed the seam weld is misaligned with top dead centre, or becomes misaligned because of pipe bowing or bending, or seam spiralling. Advantageously, the apparatus of the second aspect allows for ultrasonic inspection of pipe to be performed at different rotational positions that are in alignment with the misaligned seam weld. This allows for seam weld tracking and provides for a more efficient test procedure.

Typically the pipe is advanced into the apparatus, but the apparatus may also be advanced along the pipe.

Preferably the or each device is mounted to a carriage and the rotating means is in part incorporated into the carriage to enable the rotation of the or each device about the pipe. Mounting of the or each device in a carriage provides for greater rotational positional control as described hereafter.

Typically one or more pairs of ultrasonic transducer supporting devices are mounted to the carriage and preferably the carriage is configured such that, as a given device pair is moved relative to the pipe (eg. longitudinally or rotationally), the distance between each device in the pair is substantially preserved. In this regard, as the devices engage surface irregularities etc. the distance between each device in a given pair essentially remains a constant (although there may be infinitesimal distance changes as one device in the pair raises or lowers in respect to the pipe, relative to the other). Configuring the carriage in this manner has the advantage of maintaining a constant ultrasonic beam path between the devices in the pair, and hence a high integrity of ultrasonic testing is achieved.

In this regard, in a third aspect, the present invention provides an apparatus for positioning one or more ultrasonic transducer supporting device pairs in proximity of a pipe to enable ultrasonic defect testing thereof, the apparatus comprising means for maintaining an essentially constant distance between each device in a given pair in use.

Preferably in the third aspect the one or more device pairs are mounted to a carriage and preferably the carriage includes the rotating means of the second aspect.

Preferably in both the second and third aspects the carriage comprises a first mounting section to which the or each device (or the or each device pair) is pivotally mounted, an intermediate mounting section to which the first mounting section is pivotally mounted, and a second mounting section to which the intermediate mounting section is hinged for pivoting therearound. Whilst the intermediate mounting section can be omitted, it is typically employed to provide the carriage with an extra degree of pivoting movement.

Preferably rotation of the or each device around the pipe from a top dead centre position is effected by moving the second mounting section laterally with respect to the pipe to thereby cause the intermediate mounting section to pivot with respect to the second mounting section, and cause either or both of:

the first mounting section to pivot downwardly with respect to the intermediate mounting section;

the or each device to pivot downwardly with respect to the first mounting section;

thus moving the device(s) down and around the pipe whilst maintaining device proximity to an external surface of the pipe.

Preferably guide rollers are provided at opposite ends of the first mounting section for riding along the pipe external surface during relative movement between the pipe and the or each device, with the or each device being located on the first mounting section between the guide rollers. Thus, when the second mounting section is moved laterally with respect to the pipe, the guide rollers engage the pipe and cause the intermediate mounting section to pivot with respect to the second mounting section. The guide rollers can also facilitate rapid initial pipe alignment with the apparatus.

Preferably each guide roller is a V roller, having a V-shaped circumferential groove extending therearound between its ends, and into which groove the pipe is received in use. Preferably each roller is formed from an elastomeric material to facilitate rolling and lateral engagement with the pipe external surface.

Preferably the or each device is pivotally mounted to the first mounting section via a respective connecting arm behind which the device trails during relative movement between the device and the pipe. The connecting arm allows for individual device pivotal movement during relative device movement along or rotation around the pipe, and allows for controlled individual device displacement when traversing a hindrance. Typically each connecting arm for a given device pair is pivotally mounted via a threaded coupling to an externally threaded pin, which is in turn mounted to a cross bar of the carriage so that each device pair is supported in relation to the same cross bar. Preferably the threads are configured such that, as a given device pair is moved relative to the pipe (eg. longitudinally or rotationally), the distance between each device in the pair is substantially preserved. This arrangement provides a means by which a constant ultrasonic beam path is maintained between the devices in the pair, so that a high integrity of ultrasonic testing is achieved.

Preferably the first mounting section is pivotally mounted to the intermediate mounting section via respective coupling arm pairs behind which the first mounting section trails during relative movement between the device and the pipe. Again, the coupling arm pairs allow for pivotal movement of the first mounting section during movement along or rotation around the pipe, and allow for controlled multiple device displacement when traversing a hindrance.

Preferably the second mounting section is mounted to a framework that supports means for moving the second mounting section laterally with respect to the framework (and thereby moving the or each device laterally with respect to the pipe). Preferably the second mounting section is coupled to the lateral moving means which is in turn mounted to the framework. The lateral moving means allows for relatively fine adjustment of the or each device with respect to a pipe (eg. to track a seam weld during pipe movement therepast). Whilst typically the second mounting section (and thus the or each device) is moved laterally with respect to the framework, the pipe may alternatively be moved laterally with respect to the or each device.

Preferably the lateral moving means includes an actuating arm for moving the second mounting section along a slide mount of the framework, thereby moving the or each device laterally sideways. Preferably the actuating arm is an externally threaded rod that is rotated by a drive motor located on the framework, the rod engaging the second mounting section to cause said lateral movement.

Preferably the apparatus of the second aspect further comprises means for raising and lowering the framework (and thus the or each device) relative to the pipe to initially position the or each device in proximity of the pipe (ie. prior to feeding pipe through the apparatus).

Preferably the raising/lowering means is coupled to and acts on a supporting infrastructure to which the framework is supportingly mounted, the raising/lowering means in turn being mounted to an apparatus support frame with respect to which the infrastructure can be raised and lowered by the raising/lowering means. Preferably the infrastructure comprises a pair of opposing and transversely extending guide members in which guide rollers of the framework are supported to facilitate movement of the apparatus in the apparatus support frame.

Preferably movement of the framework on the guide rollers is caused by a drive motor mounted on the framework engaging a fixed (eg. externally threaded) rod extending across the apparatus support frame. Such movement allows for relatively coarse lateral adjustment of the or each device with respect to a pipe (eg. to preliminary locate the apparatus above a pipe to be tested, but also to move the apparatus out of pipe proximity (eg. for off-line calibration, service/maintenance, adjustment etc)).

Preferably the raising/lowering means includes two pairs of opposing screw jacks, each pair being mounted to the support frame and engageable by a respective motor driven gear rod extending across the apparatus support frame, the rotation of which causes each screw jack pair to raise or lower a respective guide member and thereby cause movement of the infrastructure up and down with respect to the apparatus support frame (which thereby causes raising and lowering of the carriage to raise and lower the or each device).

Preferably a plurality of devices or device pairs are arranged lengthwise in the carriage to be in alignment with a longitudinal axis of the pipe in use. The use of device pairs arranged laterally side-by-side allows for testing of opposite pipe halves and for verification and comparison of located defects. The lengthwise arrangement of a number of transducer supporting devices enables an increased length of pipe to be tested, resulting in more rapid testing of the whole pipe.

Preferably the apparatus is adapted in use such that the pipe can be fed through the apparatus lengthwise and such that the or each device can be brought into proximity with the leading end of the pipe, and maintained in proximity of the pipe, until a trailing end of the pipe moves past the or each device. Thus, a whole length of pipe can be ultrasonically tested in the apparatus in accordance with the present invention.

Typically the or each ultrasonic transducer supporting device used in the apparatus of the second aspect is as defined in the first aspect of the invention.

In a third aspect the present invention provides an arrangement for ultrasonic defect testing of a length of pipe comprising:
a support frame in which two or more carriages can be supported and moved, each carriage supporting one or more ultrasonic transducers for positioning in proximity of the pipe; and
means for positioning a length of pipe in proximity with one of the carriages.

Advantageously whilst one pipe section is being tested with one of the carriages, the or each other carriage can be prepared (eg. calibrated) for detecting a same or different sized or type of pipe, or can be serviced, repaired etc. whilst not in use (ie. whilst off-line).

In this regard, preferably the means for positioning the pipe length comprises a pipe support for feeding the pipe into and supporting the pipe whilst in the arrangement, and a carriage moving means operable between each carriage and the support frame for moving a given carriage into proximity of a pipe in the pipe support. Preferably the carriage moving means moves the carriages with respect to the support frame and preferably comprises the guide members, guide rollers, framework, drive motor and fixed rod extending across the support frame as per the second aspect of the invention.

Alternatively the means for positioning the pipe length can be laterally moveable with respect to the framework, such that when aligned with one of the carriages, the or each other carriage is freely accessible (eg. for adjustment, service, repair, maintenance etc.). As a further alternative, both the support frame and the advancing means can be laterally moveable.

Preferably the two or more carriages are arranged parallel to each other in the support frame, providing a simple constructional arrangement. In this regard, the carriage moving means can move the two or more carriages simultaneously to change pipe proximity from one carriage to another.

Typically each carriage of the third aspect is as defined in the second aspect, with the support frame of the third aspect able to support the apparatus of the second aspect. Preferably the one or more ultrasonic transducers referred to in the third aspect are located in a supporting device as defined for the first aspect, with each carriage supporting one or more such devices.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows a sectional side view, taken on the line 1-1 of FIG. 2, of a first ultrasonic transducer supporting device in accordance with the present invention;

FIG. 2 shows an unsectioned plan view of the device of FIG. 1;

FIG. 3 shows a sectional end view of the device of FIGS. 1 and 2, taken on the line 3-3 of FIG. 2;

FIG. 4 shows an in-use side view of the device of FIG. 1 with an ultrasonic transducer positioned thereon;

FIG. 5 shows a similar view to FIG. 4 but with a probe positioned thereon (eg. a pipe thickness probe);

FIG. 6 shows a side sectional view, taken on the line 6-6 of FIG. 7, of an alternative transducer supporting device in accordance with the present invention;

FIG. 7 shows an unsectioned plan view of the device of FIG. 6;

FIG. 8 shows an end sectional view of the device of FIGS. 6 and 7, taken on the line 8-8 of FIG. 7;

FIG. 9 shows a front view of apparatus for rotationally positioning one or more ultrasonic transducer supporting devices (eg of FIGS. 1 to 5) in proximity of a pipe in accordance with the invention;

FIG. 10 shows a front view detail of part of the apparatus of FIG. 9, being part of apparatus for laterally moving and locating a carriage in the apparatus of FIG. 9 with respect to a pipe;

FIG. 11 shows a side view of the apparatus of FIG. 9;

FIG. 12 shows a plan view detail of part of the apparatus of FIG. 11;

FIG. 13 shows a plan view of the apparatus of FIGS. 9 and 11;

FIGS. 14 and 15 each show a detail of part of the apparatus of FIG. 9 in two respective and rotationally separate positions with respect to a pipe P;

FIG. 16 shows a front view of an arrangement for supporting in parallel two of the apparatus of FIGS. 9 to 15;

FIG. 17 shows a side view of the apparatus of FIG. 16;

FIG. 18 shows an end view detail of part of the apparatus of FIG. 16 as viewed from 18-18;

FIG. 19 shows a sectional end view of part of the arrangement of FIG. 16 and taken on the line 19-19; and

FIGS. 20 to 22 show overall front, side and plan views of the arrangement of FIGS. 16 and 17, illustrating modes of use of the arrangement.

### MODES FOR CARRYING OUT THE INVENTION

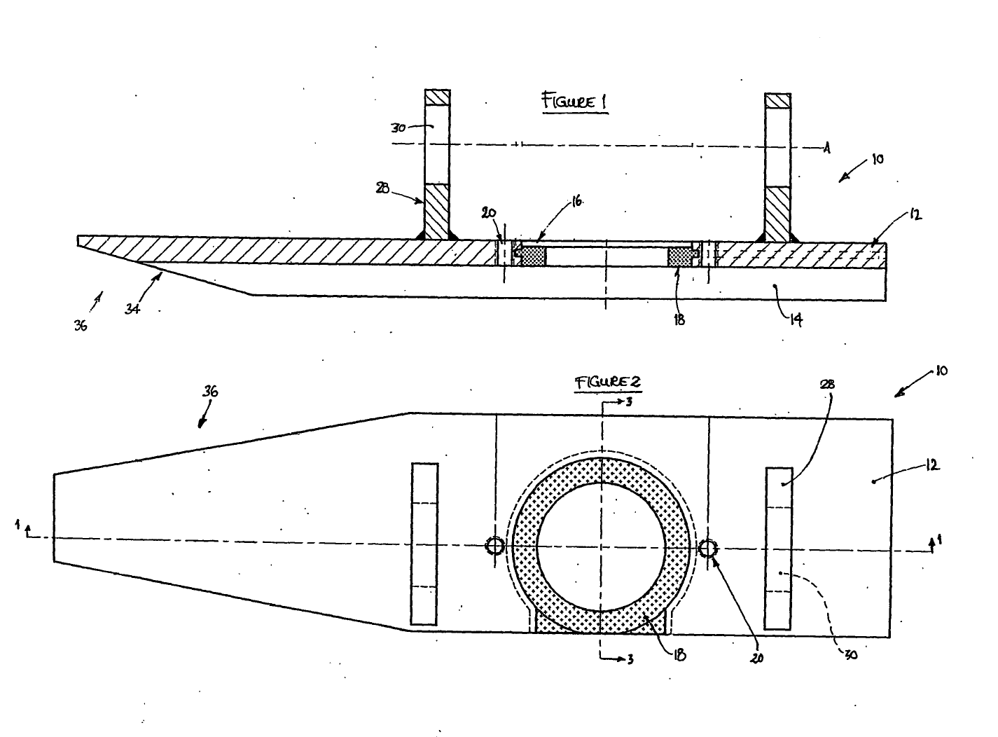

Referring firstly to FIGS. 1 to 5, a device for supporting an ultrasonic transducer or other probe is shown in the form of a ski 10. The ski includes a transducer locating portion in the form of plate 12 having a curved underside face 14 which is shaped to match the external surface of the pipe (ie. the face radius closely matches the pipe external surface radius).

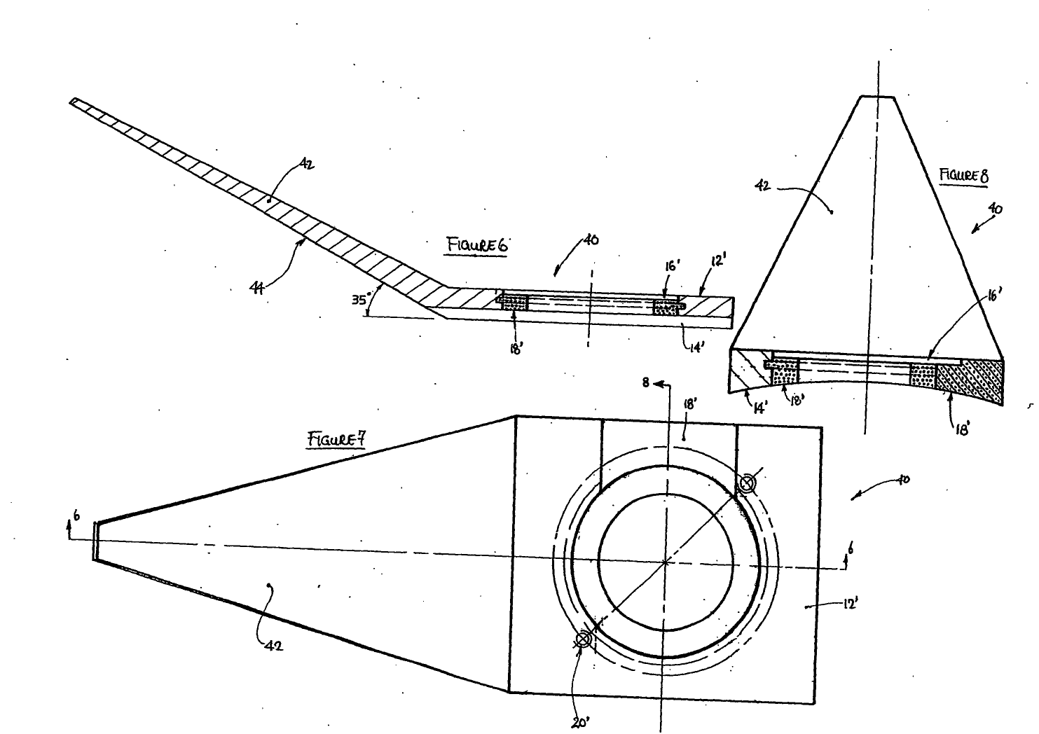

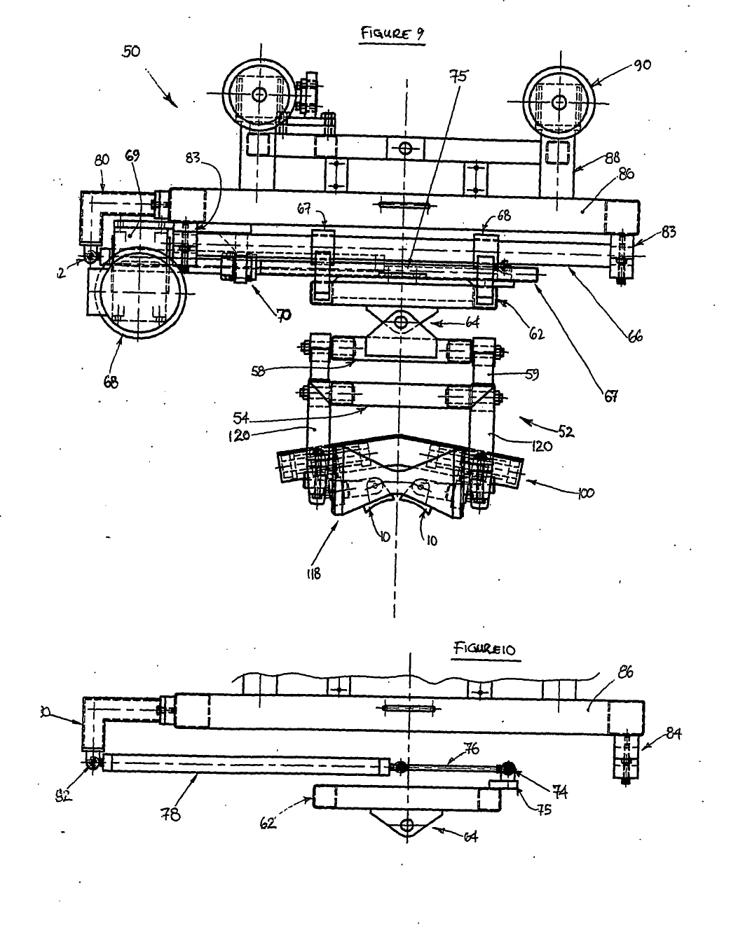

A specially shaped recess 16 is formed in the plate 12 and into which is mountingly received a polymeric (typically polyurethane) insert 18 for supporting an ultrasonic transducer or other probe. The insert is in the form of a ring, so that it laterally completely surrounds the transducer or probe when positioned therein. Typically the polyurethane has a surface resistivity of 70 to 80 durometer which has been found optimal to prevent the transmission of ultrasonic waves therethrough, so that the transducer may only propagate waves downwardly (and not laterally) from the ski and into the pipe wall. Mounting holes 20 are also provided in the plate 12 for fixedly locating bolts 22 of a transducer assembly 24 (FIG. 4) or a thickness probe assembly 26 (FIG. 5). The underside of insert 18 is curved (FIG. 3) as may be the underside of the transducer or thickness probe (not shown) so that it matches the external pipe surface curvature.

Mounted (eg. welded) to extend upwardly in use from the plate 12 are a pair of mounting fingers 28, each having a locating hole 30 therethrough. An annular bearing assembly 32 (FIGS. 4 and 5) can be located in each hole 30 to allow for ski rotation about an axis A (FIGS. 4 and 5) when each ski is mounted in positioning apparatus (as described below).

In accordance with the present invention, a guide surface in the form of undercut bevel 34 is provided (eg. machined) onto an in-use leading or forward end 36 of the ski 10. The bevel 34 facilitates engagement and traversal of any hindrances in the pipe to relative pipe/ski longitudinal movement. In FIGS. 1 to 5, bevel 34 is shown as a planar surface but may also be curved as appropriate. In addition, bevels may be formed laterally along the ski (eg. as depicted schematically by the dotted line 38 in FIG. 3) and even at an in-use rear edge of the ski (rear bevel not shown).

In use of the ski of FIGS. 1 to 5, usually a discrete length of pipe is advanced into and through ultrasonic testing apparatus housing a plurality of the skis 10. In the continuous seam welding of pipe, discrete lengths of pipe are produced by cutting from a continuously formed advancing pipe and, during the cutting process, a bevel is typically formed at the cut end and also surface deformation may occur. When such a pipe is advanced into conventional ultrasonic testing apparatus, it is necessary to lift the probes over the pipe end and lower them at a position inset therefrom to prevent damage to the probes and prevent erratic movement etc.

In accordance with the present invention, however, the end of the pipe (whether beveled or not) typically engages the probe somewhere along ski bevel 34 and rides along that bevel until the curved underside face 14 is reached, thereby making for a smooth transition, and advantageously allowing the transducer to be brought into contact with a leading end of the pipe length. This therefore enables a full length of pipe to be tested. In addition, any other hindrances (eg. surface or weld defects, irregularities, warping, bending etc) can be traversed when they engage against bevel 34, again allowing for a smooth transition of the ski relative to the pipe surface. The provision of lateral or side bevels 38 helps facilitate rotational movement of the ski 10 about a pipe, such rotational movement being described below

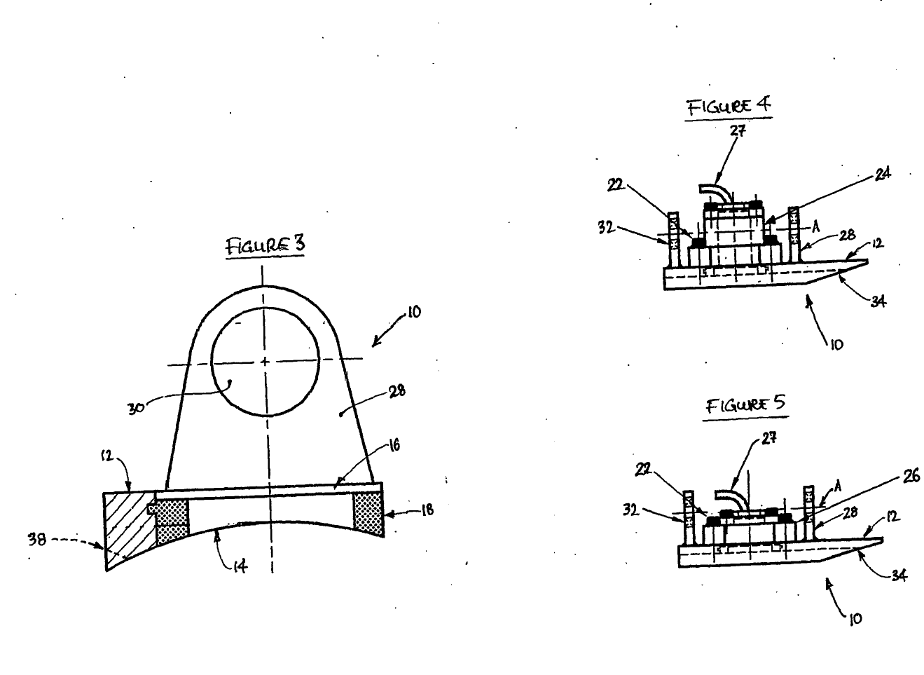

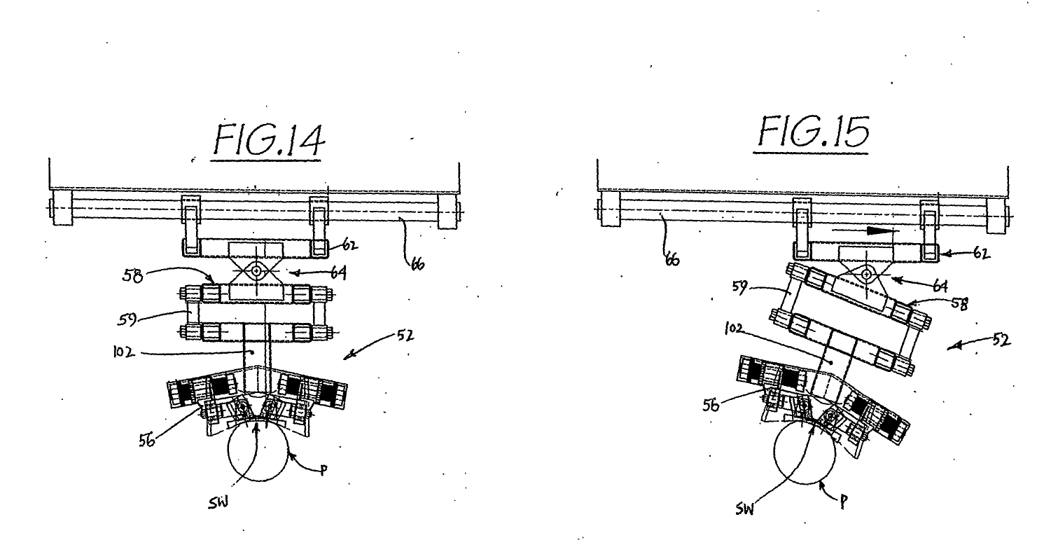

Typically the forward end 36 of ski 10 tapers inwardly as shown in FIG. 2, the taper functioning to apportion the weight of the ski along its length. This allows the ski to balance about its transverse pivot (see FIG. 12) and, under the effect of gravity, rotate itself such that its heal tends to first contact the advancing pipe and hence avoid the hooking of the leading end of the ski into the bore of the pipe which may otherwise occur, and cause damage to the assembly.

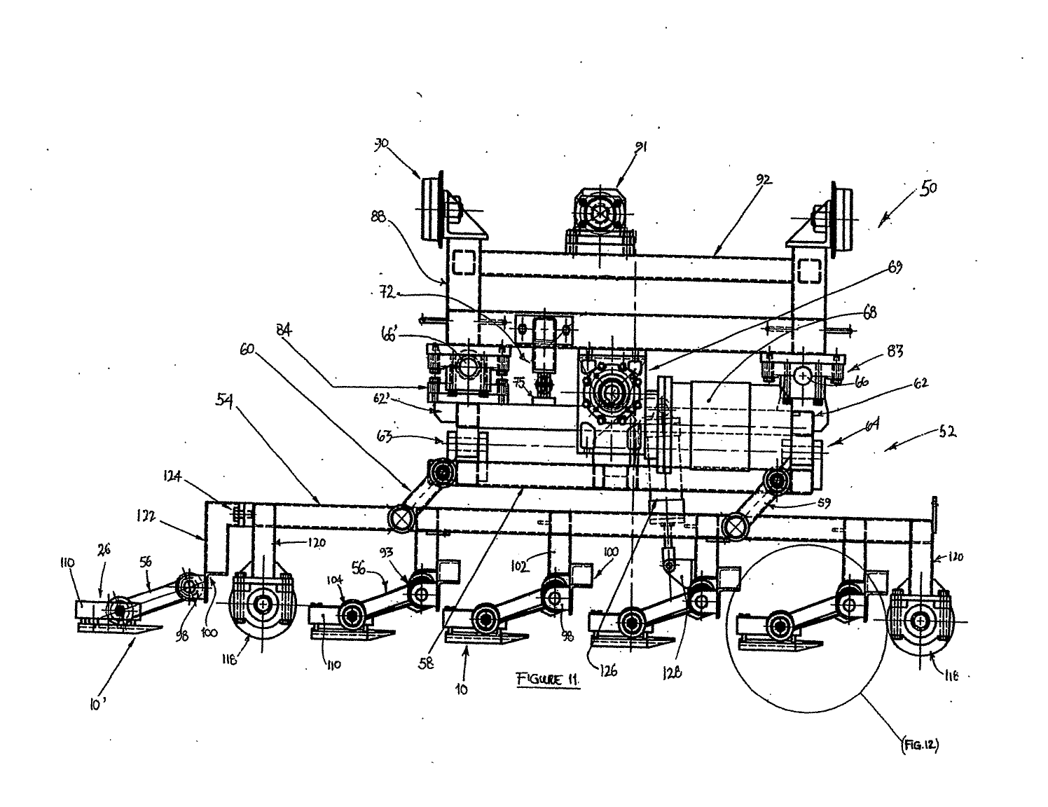

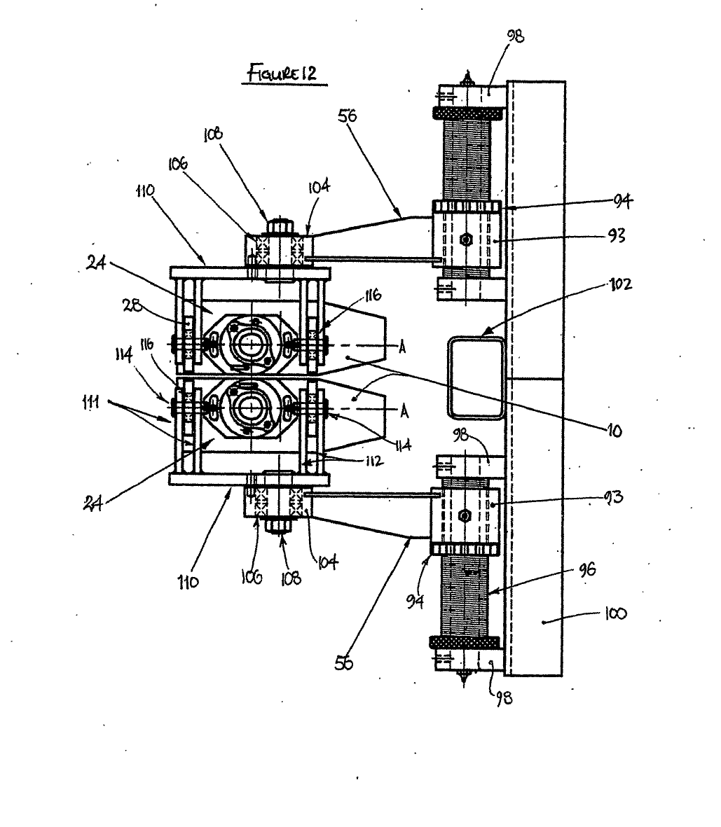

Reference will now be made to FIGS. 6 to 8, and like reference numerals will be used to denote similar or like parts. FIGS. 6 to 8 depict an alternative ski 40 having a shorter plate 12′. In this embodiment, a flange in the form of angled extension 42 projects away from plate 12′, and the guide surface is provided in the form of underside 44 of extension 42. FIG. 6 indicates that extension 42 subtends an optimal angle of 350 with a longitudinal axis through the plate 12′ (and thus with a longitudinal axis of the pipe), however, other angles can be employed. Underside 44 functions in a similar way to the bevel 34 of the ski of FIGS. 1 to 5, and thus that description of hindrance traversal applies equally to alternate ski 40.

In alternate ski 40, mounting fingers 28 are not shown but may be provided as appropriate. Alternatively, the transducer assembly or other probe can be mounted to plate 12′ via mounting holes 20′ and either not be rotatable about an axis A or the assembly or probe itself may be rotatable.

Reference will now be made to FIGS. 9 to 15, where like reference numerals are used to denote similar or like parts. FIGS. 9 to 15 show apparatus 50 for rotationally positioning a plurality of the skis 10 of FIGS. 1 to 5 about a pipe P (eg. to allow weld seam tracking). Either a transducer assembly 24 or a thickness probe assembly 26 can be arranged in each ski.

The apparatus 50 includes a carriage in the form of a carrier 52. Carrier 52 includes a first mounting section in the form of ski support chassis 54. Each ski is pivotedly mounted to chassis 54 via a respective connecting arm 56 (described below and shown in detail with reference to FIG. 12). Ski support chassis 54 is in turn pivotedly mounted to an intermediate mounting section in the form of intermediate frame 58 via coupling arm pairs 59, 60. Intermediate frame 58 is rotatably coupled to a second mounting section in the form of suspended frame 62 via an opposing hinge pair arrangement 63,64.

The suspended frame is moveable laterally in the apparatus for fine adjustment of ski location (eg. to react to seam weld deviations). In this regard, lateral movement of the suspended frame causes lateral movement of the carrier 52 enabling the skis to be rotated around the pipe and to track a deviating weld (as described below).

To facilitate and control lateral movement of the suspended frame 62, the suspended frame is slidably mounted to front and rear support bars 66, 66′ via a pair of slide couplings 67, 68. Suspended frame 62 is moved laterally left and right (FIG. 9) along support bar 66 via a drive rod 67 which is coupled to the suspended frame 62 and which is moved laterally left and right by a drive motor 68 and gearbox 69, the rod also being supported in bearing 70. In this regard, typically the drive rod 67 is externally threaded such that actuation of the drive motor causes the gearbox to engage the rod and move it, and hence move the suspended frame.

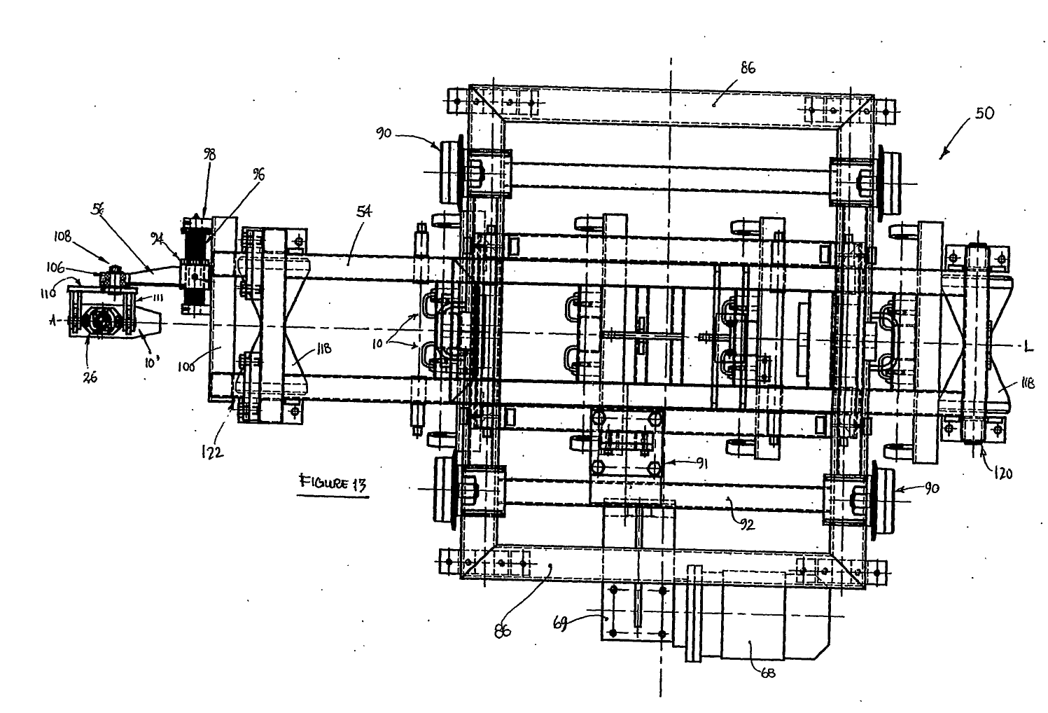

Referring now to FIGS. 10 and 11, a position transducer assembly 72 is depicted, the position transducer enabling the precise location of suspended frame 62 to be determined and controlled. In this regard, and as best shown in FIG. 11, the position transducer assembly 72 is located behind and is connected via connections 74, 75 adjacent to a rear portion 62′ of the suspended frame 62. Connection 74 is inturn connected to a rod 76 which slides within position detection tube 78. Tube 78 is connected to a support arm 80 via a connection 82 and has a lateral position transducer built thereinto to detect and thus control precise lateral positioning of suspended frame 62 and thereby the carrier 52.

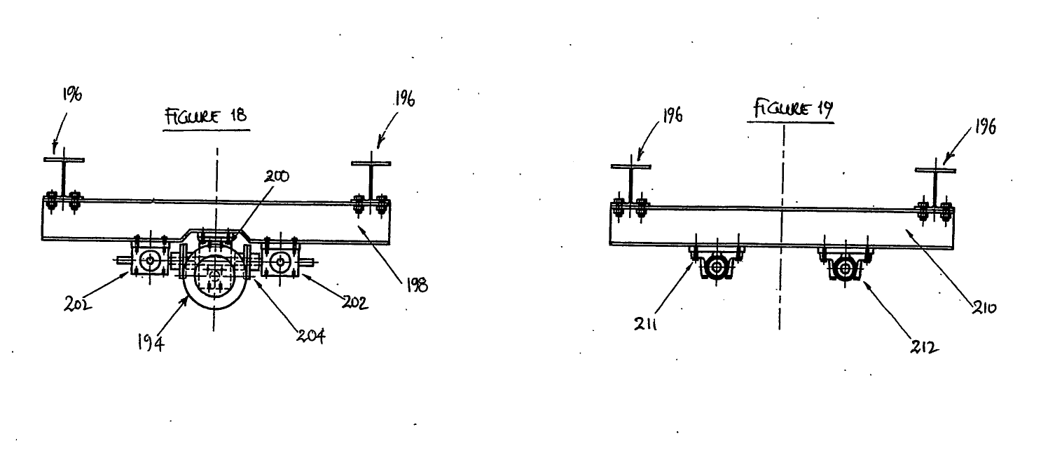

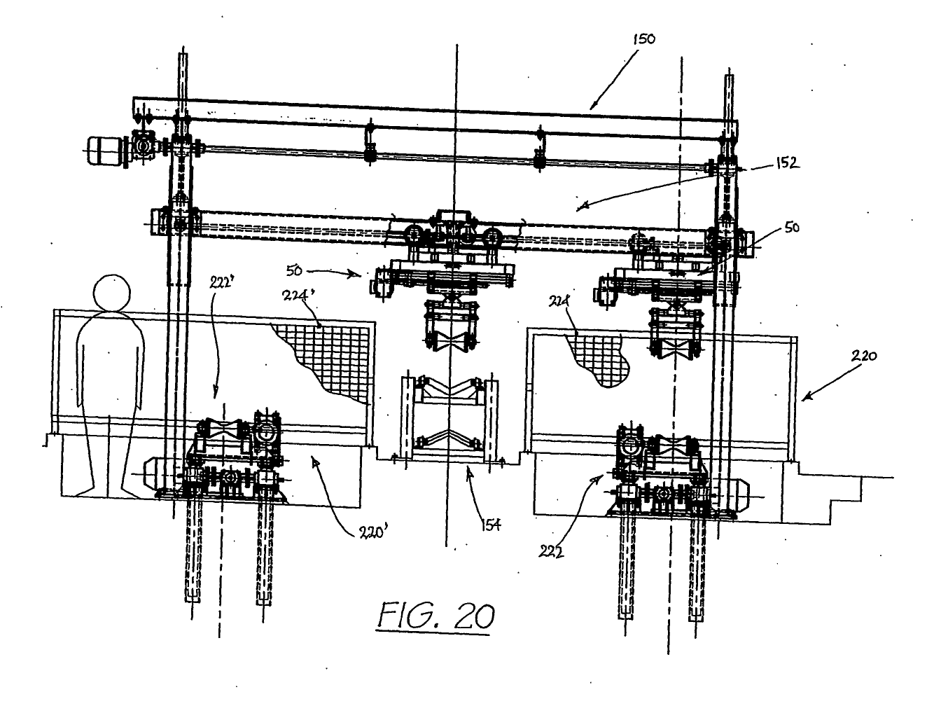

Referring again to FIGS. 9 and 11, support bars 66, 66′ are connected at their ends by respective front and rear connectors 83,84 to rectangular framework 86. Extending upwardly from the framework and mounted on four respective support columns 88 are track wheels 90. The track wheels ride on and are supported by components of an infrastructure that supports two like apparatus 50 in parallel operations (described below with reference to FIGS. 16 to 19). The track wheels allow the apparatus 50 to be moved laterally in the infrastructure, the lateral movement being caused by a motor acting on a rod extending through a thrust bearing 91 (described below in FIGS. 16 to 18). Thrust bearing 91 is mounted on a frame 92 extending between the columns 88. This lateral movement allows for coarse alignment of the apparatus with a pipe, and with pipe feed apparatus, and also allows for its movement away from the pipe for apparatus calibration, servicing etc (see FIG. 20).

Referring now to FIG. 12 (but as also shown in FIGS. 9 and 11) the ski 10 pivots with respect to ski support chassis 54 via a connecting arm 56. One end of the connecting arm includes a ring 93 with an internally threaded bush 94 fasteningly mounted therein. This end of the connecting arm rotates and threadingly engages an externally threaded pin 96 which is mounted between supports 98, and which in turn are connected via bracket 100 to connecting post 102. Connecting post 102 is in turn mounted to ski support chassis 54 as shown in FIG. 11 (note: post 102 is omitted from FIG. 9 for clarity).

As can also be seen in FIG. 12, the threads on each pin 96 are parallel to the other so that as the ring 93 of each connecting arm 56 rotates on its respective pin the parallel skis are maintained at a constant distance apart and do not collide into each other. Thus, as the skis engage surface irregularities etc. the distance between each ski in a given pair essentially remains a constant (allowing for infinitesimal distance changes as one ski in the pair raises or lowers in respect to the pipe, relative to the other). Arranging the skis in this manner has the advantage of maintaining a constant ultrasonic beam path between adjacent skis so that a high integrity of ultrasonic testing is achieved.

The opposite end of each connecting arm 56 is provided with a ring 104 into which two roller bearing assemblies 106 are positioned. A supporting nut and bolt arrangement 108 extends through ring 104 and the roller bearing assemblies 106 to provide for a pivotal coupling. The bolt 108 is retained in a ski support plate 110 from which laterally extends two pairs of ski support arms 111, 112. Pins 114 extend through those arms, and each mounting finger 28 is arranged to locate between arms 111 or 112 and be retained by pin 114. In addition, a roller bearing 116 is positioned and retained in the locating hole 30 of each finger 28 to provide for ski rotation about pins 114 (ie. about axis A).

Thus, a high degree of pivoting and rotational movement is provided to each ski, and this allows for its precise positioning in proximity of a pipe external surface, and further enhances each ski's capacity to traverse hindrances during relative movement between the pipe and ski in use.

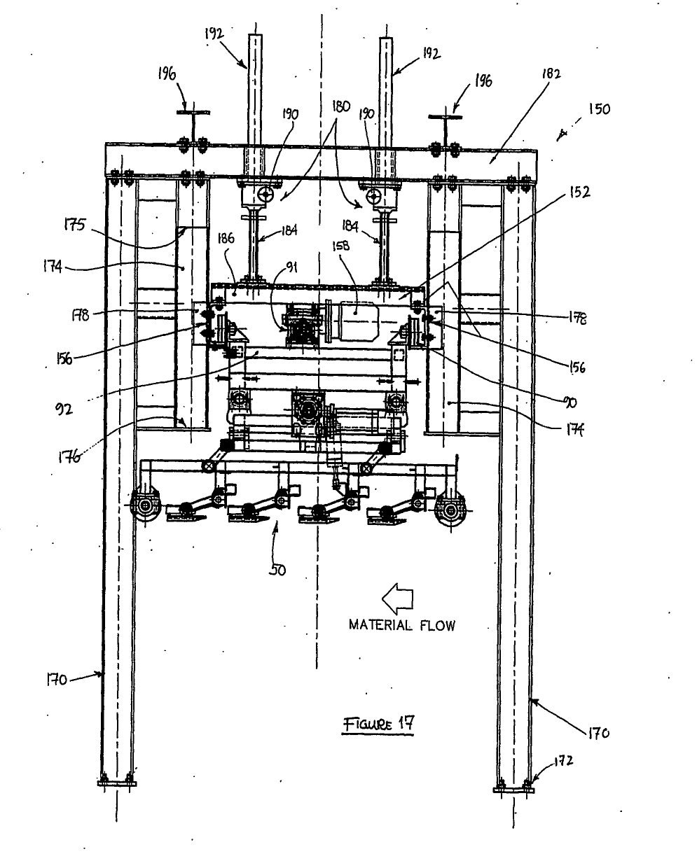

Referring again to FIGS. 9, 11 and 13, a pair of V-shaped grooved guide rollers 118 are mounted at opposite ends of ski support chassis 54, each guide roller being supported between a pair of downwardly extending posts 120. The guide rollers facilitate both initial engagement and alignment of the carrier with an advancing pipe and final pipe disengagement of the carrier. In addition, the guide rollers maintain carrier alignment with the pipe during relative movement between the carrier and pipe. Furthermore, during rotation of the carrier around a pipe, the guide rollers, in conjunction with the skis, facilitate pivoting of parts of the carrier, as described below with reference to FIGS. 14 and 15.

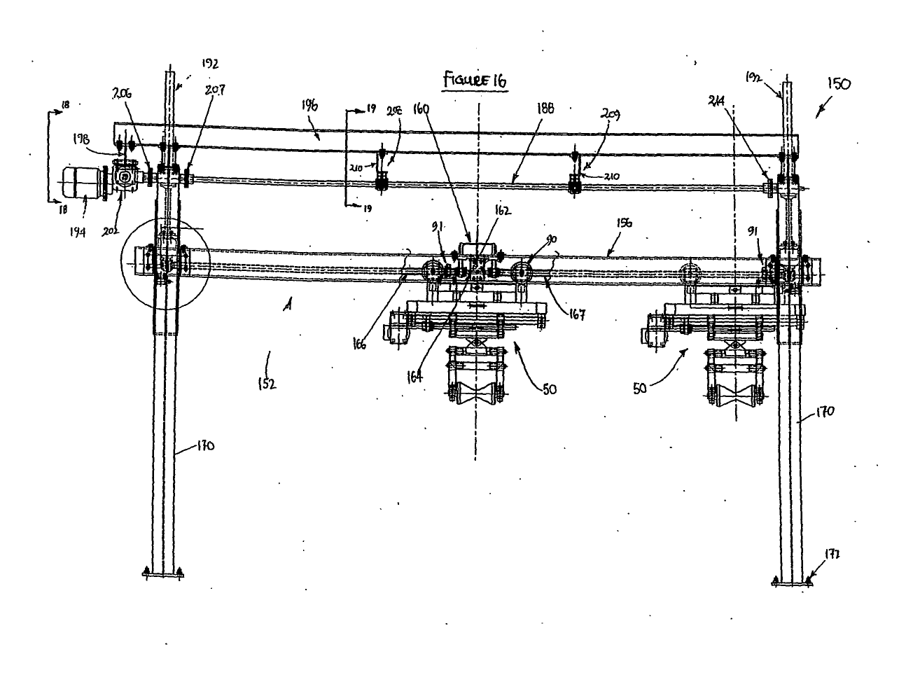

As shown in FIGS. 11 and 13, the carrier is also provided with a single trailing thickness probe assembly 26 mounted on its own respective ski 10′. The thickness probe is positioned in use to align with a longitudinal axis L through the carrier (see FIG. 13) which in plan view and in use aligns with a longitudinal axis of a pipe. With particular reference to FIG. 13, where like reference numerals are used to denote like parts to that of FIG. 12, the coupling arrangement of ski 10′ to the carrier is similar to each of the other skis 10. However, connecting arm 56 has been advanced along pin 96 so that the axis A through ski 10′ aligns with longitudinal axis L of the carrier. In addition, the bracket 100 is mounted to a special leg 122 which is bolted at 124 (FIG. 11) to a trailing end of ski support chassis 54. Thus, the thickness probe ski 10′ trails behind the trailing roller 118. The thickness probe is provided to measure seam weld thickness as part of the test procedure to detect for any potential areas of weakness or irregularity which might lead to pipe failure in use. In other words, the carrier 52 according to the present invention can be used to support probes and testing equipment other than ultrasonic defect testing probes.

To move the chassis 54 out of the way of a pipe etc during coarse movement of the apparatus, or to tilt the chassis for transducer access during servicing etc, an auxiliary motor 126 can extend from the suspended frame 62 and be connected at its opposite end to a flange 128 attached to one of the posts 102.

As shown, the carrier locates eight ultrasonic transducer probes in proximity of a pipe, with typically four being in longitudinal alignment on one side of the seam weld and four being in alignment on the other side of the seam weld. Thus, at a given position along the pipe, typically a pair of transducers are positioned on either side of the seam weld. This arrangement allows for rapid testing of reasonably long lengths of pipe (eg. typically there is approximately a meter's length between the leading probe pair and the trailing probe pair). In addition, it allows for rapid and precise ultrasonic circumferential testing and axial testing.

Referring now to FIGS. 14 and 15, the rotation of the carrier 52 around a pipe P to track a deviating seam weld SW is schematically illustrated. FIG. 14 shows the carrier 52 in its usual vertical orientation (after both coarse and fine carrier alignment). This is the carrier orientation adopted when the pipe seam weld SW is located at top dead centre of the pipe.

Referring now to FIG. 15, sometimes the seam weld in an advancing pipe deviates from top dead centre. This can occur in a number of ways. For example, deviation can be caused by operator feeding error or apparatus alignment error. Alternatively, the seam weld can become misaligned due to pipe bowing or seam spiralling. In any case, the carrier according to the present invention allows for the ultrasonic transducer support skis 10 to be rotated around the pipe to track the seam weld and maintain it between a given pair of ultrasonic transducers (as shown in FIG. 15). In this regard, the suspended frame 62 is moved laterally with respect to the framework 86. Because the guide rollers 118, skis 10 and transducers are in frictional contact with the pipe external surface, they provide resistance to lateral movement, which is translated from the pipe through connecting arms 56 and coupling arm pairs 59,60 to the suspended frame 62. Thus, during suspended frame lateral movement the skis retain their contact with the pipe external surface. To allow for this, the intermediate frame 58 pivots about the hinge pair arrangement 63,64 and, because the carriage has dipped, the coupling arm pairs 59,60 pivot at their respective ends, to increase the overall length of the carrier (as shown in FIG. 15). Although not specifically shown in FIG. 15, the left hand ski can pivot upwardly on its respective connecting arm 56 and the right hand ski can pivot downwardly on its respective connecting arm 56 to maintain the skis in proximity of the pipe external surface.

The apparatus has been designed to allow for up to 20° of rotation of each ski pair about the pipe external surface, as it is extremely unlikely that the seam weld misalignment would be ever beyond 20° off top dead centre, but the apparatus can be adapted for greater rotation if necessary. In addition, the apparatus has been designed such that tracking of the seam weld can be controlled visually by an operator or automatically by a sensor that follows a witness line that is offset from the weld centreline. Typically this witness line is previously applied in conjunction with seam welding where the actual position of the seam weld centreline is precisely known.

Referring now to FIGS. 16 to 22, where like reference numerals are used to denote similar or like parts, a supporting superstructure 150 for two like apparatus 50 operating in parallel is depicted. The supporting superstructure can be adapted for supporting more than two apparatus but will be described hereafter with reference to the support of two apparatus. The supporting superstructure includes an infrastructure 152 for supporting each apparatus 50 and for allowing raising and lowering of each apparatus in relation to a pipe feed station 154 (FIG. 20).

Infrastructure 152 comprises a pair of opposing channels 156, each for supporting a pair of the track wheels 90 for rolling movement along and within the channel. As described above, the track wheels 90 allow each apparatus 50 to be moved laterally from left to right FIG. 16) to align one of the apparatus with pipe feed station 154, whilst the other apparatus is located off-line for calibration, servicing etc.

Apparatus lateral movement is facilitated as follows. A drive motor 158 (FIG. 17) is mounted to a transverse housing member 160 (FIG. 16) extending between the channels 156. The drive motor and a gearing driven thereby is mounted to support plate 162 extending from housing member 160 (FIG. 16) for geared engagement with a drive rod 164. The drive rod 164 is inturn coupled to left and right apparatus drive rods 166, 167, which each extend through a respective thrust bearing 91 mounted to each apparatus 50. Thus, rotation of the drive rod 164 and thence the apparatus drive rods 166, 167 in opposite directions is translated by thrust bearing 91 to cause each apparatus 50 to move laterally left or right (ie. depending on the rod rotational direction). Thus, the two apparatus move simultaneously when drive motor 158 is actuated, although each may be independently controlled. For example, each may have its own respective drive motor associated therewith or, more preferably, respective drive motors can be located at remote opposing ends of the infrastructure 152. Remote location minimises electrical/electronic interference with the ultrasonic transducers which can occur when the motors are in too close proximity thereto.

The infrastructure 152 is able to be raised and lowered with respect to the superstructure 150 to raise and lower apparatus 150. In this regard, the superstructure 150 comprises four uprights 170. Each upright is bolted 172 to the floor of the ultrasonic testing facility.

As shown in FIG. 17, guide frames 174 extend inwardly from each upright 170, with each guide frame having upper and lower stops 175, 176. The stops delimit the extent of upward and downward movement of the infrastructure 152. In this regard, buffers 178 are mounted to each channel 156 and engage against the stops 175,176 at upper and lower limits of infrastructure travel.

To raise and lower infrastructure 152, two pairs of screw jacks 180 are provided on each side of superstructure 150, each mounted to extend down from cross frame member 182. Each screw jack comprises a ram 184 which is connected at its lower end to infrastructure support member 186, with member 186 extending between and connecting to channels 156 adjacent to ends thereof. In other words, a pair of screw jacks is provided at each side of the superstructure (ie. as viewed in FIG. 16) to support opposing ends of each channel and to raise and lower the same.

The rams 184 are driven within each screw jack 180 in conjunction with a rod 188 (FIG. 16). A rod 188 extends between gear drive mounts 190 for each pair of opposing screw jacks. In addition, as each ram is drawn upwardly, it extends into tubular extension housing 192 of the screw jack, and when the infrastructure is lowered, each ram extends downwardly out of that housing.

Referring now to FIGS. 16, 18 and 19, a drive motor 194 for driving of the screw jacks is suspended between a pair of transverse beams 196, each beam 196 extending between and mounted to cross frame members 182. A motor support beam 198 subtends from beams 196, the motor being mounted to the underside of that beam via mounting 200. The drive motor is engaged to mitre gear boxes 202 via couplings 204, and each mitre gear box is inturn coupled to a respective drive rod 188 via couplings 206, 207 (FIG. 16). The couplings 206, 207 are located on either side of a respective screw jack at gear drive mount 190 and couple the mitre gear box to the screw jack and thence to the drive rod 188.

Thus, a pair of drive rods extend across the superstructure, with each drive rod extending between an opposing pair of screw jacks. Each drive rod is supported at two locations 208, 209 as shown more clearly in FIG. 19. In this regard, at each location a rod support beam 210 subtends from and extends between the transverse beams 196. A pair of support bearings 211, 212 are mounted to the rod support beam 210 and through and in which the rod extends and is rotationally supported. At the right hand end of drive rod 188 (FIG. 16) the drive rod is coupled to a respective screw jack gear drive mount 190 via coupling 214.

Thus, actuation of motor 194 rotates the mitre gear boxes 202 and thereby drive rods 188, causing the screw jacks to either raise or lower the support members 186 and thus the channels 156. This in turn raises or lowers both of the apparatus 50, enabling the apparatus to be positioned vertically with respect to a pipe located in the pipe feed station 154, to coarsely adjust the apparatus for different pipe diameters.

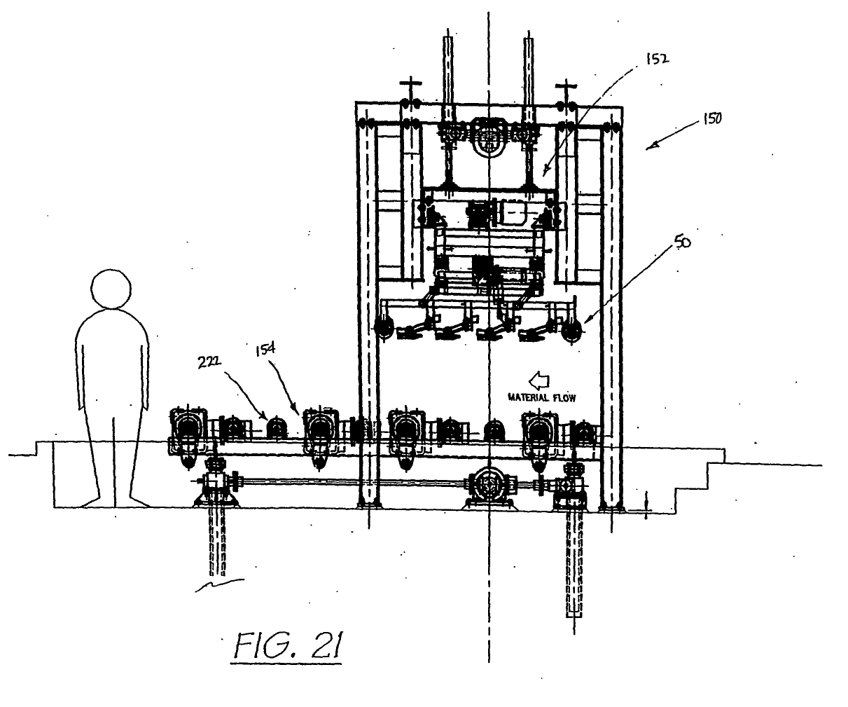

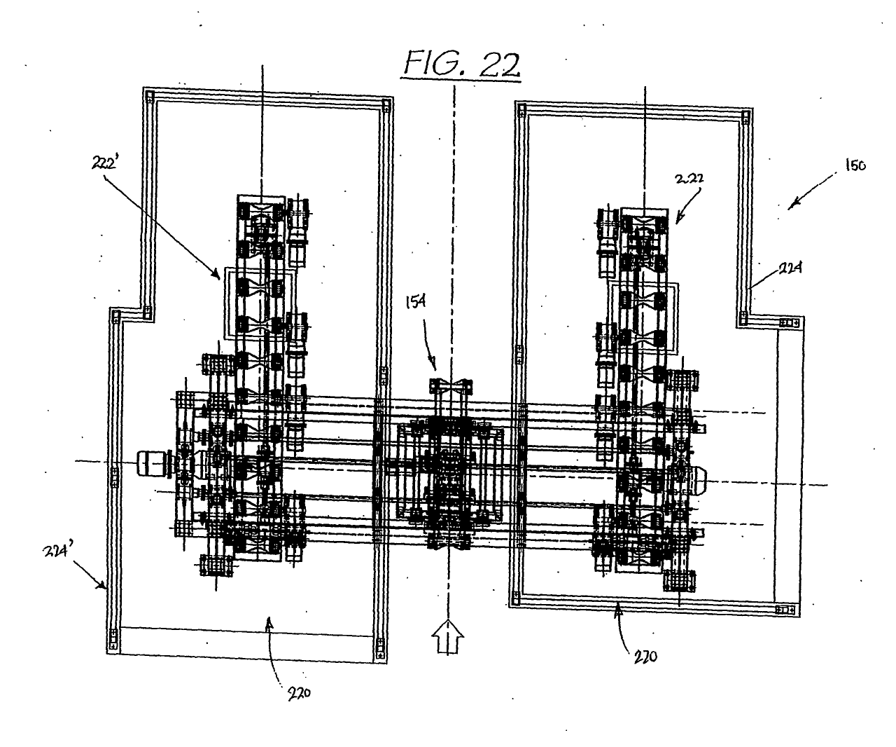

Referring now to FIGS. 20 to 21, it will be seen that whilst one apparatus (left hand apparatus) is positioned above the pipe feed station 154 ready to receive a pipe therein for ultrasonic testing, the other apparatus 50 (right hand apparatus) is positioned above a respective calibration station 220. In calibration station 220 the right hand apparatus 50 can be calibrated ready to receive a different pipe for testing. Advantageously this means there is effectively no down time when changing over between pipes of different sizes. In addition, in the location shown the right hand apparatus can be serviced, repaired etc., so that down time is again minimised or eliminated. Similarly, when the left hand apparatus 50 is out of service it is positioned above its own calibration station 220′ and then the right hand apparatus 50 is now positioned above the pipe feed station 154.

It will also be seen that each calibration station has its own pipe feed mechanism 222 for feeding in a pipe to be calibrated. In addition, each calibration stage typically has a safety cage arrangement 224 positioned therearound.

Whilst a two apparatus superstructure has been depicted the structure can readily be widened to accommodate additional apparatus 50.

Thus, whilst the invention has been described with reference to a number of preferred embodiments, it should be appreciated that the invention can be embodied in many other forms.

1. A device for supporting an ultrasonic transducer used for ultrasonic defect testing of pipe, the device comprising:
a transducer locating portion adapted for positioning adjacent to a pipe to locate the transducer in proximity of the pipe; and
a guide surface that is fixed against movement in relation to the transducer locating portion, the guide surface being adapted such that, when the device is moved relative to the pipe, the guide surface can engage and traverse hindrances in the pipe to such relative device movement.

2. A device as claimed in claim 1 wherein the guide surface is located forwardly in the transducer locating portion when the device is moved relatively lengthwise along the pipe.

3. A device as claimed in claim 1 wherein in use the guide surface extends obliquely with respect to a longitudinal axis of the pipe.

4. A device as claimed in claim 1 wherein the guide surface is defined:
(i) at an end of the transducer locating portion; or
(ii) as part of a flange extending away from the transducer locating portion.

5. A device as claimed in claim 4 wherein in (i) the guide surface is defined as a bevel undercut at an in-use forward end of the device.

6. A device as claimed in claim 4 wherein in (ii) the flange extends away from an in-use forward end of the device and away from the pipe, and the guide surface is defined on a side of the flange facing the pipe.

7. A device as claimed in claim 1 wherein the guide surface is planar.

8. A device as claimed in claim 1 wherein a transducer locator element is disposed within the transducer locating portion, into which element the transducer is mountingly located in use.

9. A device as claimed in claim 8 wherein the transducer locator element laterally surrounds the transducer and is formed from a material resistant to the propagation of ultrasonic waves therethrough, such that ultrasonic waves are not directed laterally through the device in use.

10. A device as claimed in claim 8 wherein the transducer locator element is formed from a ring of polymeric material positionable in a body of the transducer locating portion.

11. A device as claimed in claim 1 wherein the transducer locating portion includes a curved in-use underside surface for close-facing positioning with the pipe in use.

12. A device as claimed in claim 11 wherein the curved surface is defined by a radius that is closely matched to a radius defining the external surface of the pipe.

13. A device as claimed in claim 1 that is adapted for mounting in an apparatus for moving the device relatively along and/or around and/or towards/away from the pipe in use.

14. A device as claimed in claim 13 wherein a plurality of the ultrasonic transducer supporting devices are mountable in the apparatus.

15. (canceled)

16. An apparatus for rotationally positioning one or more ultrasonic transducer supporting devices in proximity of a pipe to enable ultrasonic defect testing thereof, the apparatus comprising a carriage to which the or each device is mounted, and a means for rotating the or each device around at least part of the pipe's circumference whilst maintaining the or each device in proximity of the pipe, wherein the rotating means is in part incorporated into the carriage to enable the rotation of the or each device about the pipe.

17. Apparatus as claimed in claim 16 wherein one or more pairs of ultrasonic transducer supporting devices are mounted to the a carriage, and wherein the carriage is configured that, as a given device pair is moved relative to the pipe, an essentially constant distance between each device in the pair is maintained.

18. Apparatus as claimed in claim 17 wherein the distance is maintained between each device by connecting each device via a respective arm to a portion of the carriage, and by providing an internally threaded sleeve at the arm end that receives therethrough and that is mounted for rotational movement thereon and therealong of an externally threaded shank, the shank in turn being mounted to the carriage portion.

19. An apparatus for positioning one or more ultrasonic transducer supporting device pairs in proximity of a pipe to enable ultrasonic defect testing thereof, the apparatus comprising a carriage to which each device in a pair is pivotally mounted, and means for maintaining an essentially constant distance between each device in a given pair during differential pivoting of the device in that pair with respect to the carriage in use.

20. Apparatus as claimed in claim 19 wherein the carriage includes the rotating means as claimed in claim 16.

21. Apparatus as claimed in claim 18 wherein the carriage comprises a first mounting section to which the or each device is pivotally mounted, an intermediate mounting section to which the first mounting section is pivotally mounted, and a second mounting section to which the intermediate mounting section is hinged for pivoting therearound.

22. Apparatus as claimed in claim 21 wherein one or more ultrasonic transducer supporting device pairs are each pivotally mounted to the first mounting section via the carriage portion, the or each carriage portion comprising respective section for mounting a corresponding shank portion, the respective carriage section orienting an elongate axis of the shank portion such that it is parallel to a tangent line to the pipe surface adjacent to the respective transducer supporting device, with this arrangement contributing to the maintenance of the essentially constant distance between the devices in a given pair.

23. Apparatus as claimed in claim 21 wherein the rotation of the or each device around the pipe from a top dead centre position is effected by moving the second mounting section laterally with respect to the pipe to thereby cause the intermediate mounting section to pivot with respect to the second mounting section, and cause either or both of:
the first mounting section to pivot downwardly with respect to the intermediate mounting section;
the or each device to pivot downwardly with respect to the first mounting section;
thus moving the device(s) down and around the pipe whilst maintaining device proximity to an external surface of the pipe.

24. Apparatus as claimed in claim 23 wherein guide rollers are provided at opposite ends of the first mounting section for riding along the pipe external surface during relative movement between the pipe and the or each device, with the or each device being located on the first mounting section between the guide rollers.

25. Apparatus as claimed in claim 24 wherein, when the second mounting section is moved laterally with respect to the pipe, the guide rollers engage the pipe and cause the intermediate mounting section to pivot with respect to the second mounting section.

26. Apparatus as claimed in claim 24 wherein each guide roller is a V roller, having a V-shaped circumferential groove extending therearound between its ends, and into which groove the pipe is received in use.

27. Apparatus as claimed in claim 24 wherein each roller is formed from an elastomeric material to facilitate rolling and lateral engagement with the pipe external surface.

28. Apparatus as claimed in claim 21 wherein the or each device is pivotally mounted to the first mounting section via a respective connecting arm behind which the device trails during relative movement between the device and the pipe.

29. Apparatus as claimed in claim 21 wherein the first mounting section is pivotally mounted to the intermediate mounting section via respective coupling arm pairs behind which the first mounting section trails during relative movement between the device and the pipe.

30. Apparatus as claimed in claim 21 wherein the second mounting section is mounted to a framework that supports means for laterally moving the second mounting section with respect to the framework.

31. Apparatus as claimed in claim 30 wherein the second mounting section is coupled to the lateral moving means which is in turn mounted to the framework.

32. Apparatus as claimed in claim 30 wherein the lateral moving means includes an actuating arm for moving the second mounting section along a slide mount of the framework, thereby moving the or each device laterally sideways.

33. Apparatus as claimed in claim 32 wherein the actuating arm is an externally threaded rod that is rotated by a drive motor located on the framework, the rod engaging the second mounting section to cause said lateral movement.

34. Apparatus as claimed in claim 30 further comprising means for raising and lowering the framework relative to the pipe to initially position the or each device in proximity of the pipe, the raising/lowering means being coupled to and acting on a supporting infrastructure to which the framework is supportingly mounted, the raising/lowering means in turn being mounted to an apparatus support frame raising/lowering means.

35. Apparatus as claimed in claim 34 wherein the infrastructure comprises a pair of opposing and transversely extending guide members in which guide rollers of the framework are supported to facilitate movement of the apparatus in the apparatus support frame.

36. Apparatus as claimed in claim 35 wherein movement of the framework on guide rollers is caused by a drive motor mounted on the framework engaging a fixed rod extending across the apparatus support frame.

37. Apparatus as claimed in claim 35 wherein the raising/lowering means includes two pairs of opposing screw jacks, each pair being mounted to the support frame and engageable by a respective motor driven gear rod extending across the apparatus support frame, the rotation of which causes each screw jack pair to raise or lower a respective guide member and thereby cause movement of the infrastructure up and down with respect to the apparatus support frame.

38. Apparatus as claimed in claim 16 wherein a plurality of devices or device pairs are arranged lengthwise in the carriage to be in alignment with a longitudinal axis of the pipe in use.

39. Apparatus as claimed in claim 16 that is adapted in use such that the pipe can be fed through the apparatus lengthwise so that the or each device can be brought into proximity with the leading end of the pipe, and maintained in proximity of the pipe, until a trailing end of the pipe moves past the or each device.

40. Apparatus as claimed in claim 16 wherein the or each ultrasonic transducer supporting device is as defined in claim 1.

41. (canceled)

42. An arrangement for ultrasonic defect testing of lengths of pipe comprising:
a support frame in which two or more carriages can be supported and moved, each carriage supporting one or more ultrasonic transducers for positioning in proximity of the pipe; and
means for positioning a length of pipe in proximity with one of the carriages.

43. An arrangement as claimed in claim 42 wherein the means for positioning the pipe length comprises a pipe support for feeding the pipe into and supporting the pipe whilst in the arrangement, and a carriage moving means operable between each carriage and the support frame for moving a given carriage into proximity of a pipe in the pipe support.

44. An arrangement as claimed in claim 43 wherein the carriage moving means comprises the guide members, guide rollers, framework, drive motor and fixed rod extending across the support frame as defined in claim 36.

45. An arrangement as claimed in claim 43 wherein the two or more carriages are arranged in parallel to each other in the support frame such that the carriage moving means can move the two or more carriages simultaneously to change pipe proximity from one carriage to another.

46. An arrangement as claimed in claim 42 wherein each carriage is as defined in claim 17.

47. An arrangement as claimed in claim 42 wherein the framework incorporates or comprises apparatus as defined in claim 16.

48. An arrangement as claimed in claim 42 wherein the one or more ultrasonic transducers are located in a supporting device as defined in claim 1, with each carriage supporting one or more such devices.

49. (canceled)

50. Apparatus as claimed in claim 19 wherein the means for maintaining the distance is as defined in claim 18.
